(19) United States
(12) Patent Application Publication
(10) Pub. No.: US 2012/0083555 A1
(43) Pub. Date: Apr. 5, 2012

(54) HIGH TEMPERATURE RESISTANT PLASTIC COMPOSITE WITH MODIFIED LIGNO-CELLULOSE

(75) Inventor: HANS KORTE, WISMAR (DE)

(73) Assignee: NEW POLYMER SYSTEMS, INC., NEW CANAAN, CT (US)

(21) Appl. No.: 13/244,304

(22) Filed: Sep. 24, 2011

Related U.S. Application Data
(60) Provisional application No. 61/404,476, filed on Oct. 4, 2010.

(51) Int. Cl. C08L 97/02

(52) U.S. Cl. 524/14; 524/13

(57) ABSTRACT

A high temperature resistant composite is disclosed that is made from modified ligno-cellulose and polymers, wherein the modified ligno-cellulose has a molar ratio of oxygen to carbon (O/C) from 0.3 to 0.6 and has a molar ratio of hydrogen to carbon (H/C) from 0.9 to 1.6 and the polymers belong to the group of thermoplastic polymers.

### CROSS-REFERENCE TO RELATED APPLICATION

The present application claims the benefit of previously filed co-pending Provisional Patent Application, Ser. No. 61/404,476.

### FIELD OF THE INVENTION

This invention belongs to the field of manufacture of plastic composites. More specifically it is a high temperature resistant composite from modified ligno-cellulose and polymers, wherein the modified ligno-cellulose has a molar ratio of oxygen to carbon (O/C) from 0.3 to 0.6 and a molar ratio of hydrogen to carbon (H/C) from 0.9 to 1.6 and the polymers belong to the group of thermoplastic polymers.

### BACKGROUND OF THE INVENTION

Composites made from natural fibres as fillers and thermoplastic polymers as matrix natural fibre plastic composites (NFPC) have been developed as a new material group in the beginning of the 1990's in North America. Mostly the fibre content is more than 50% (w/w) and wood is the most used fibre type. Profile extrusions of wood filled polyolefins are the most used application.

A typical example of this technology is given in U.S. Pat. No. 5,516,472. Besides one-step direct extrusion two-step processes with a compounding step first and an extrusion step second are common (EP 0 667 375 B1). NFPC are of high commercial interest due to much lower costs for natural fibres compared to bulk plastics like polyolefins or technical plastics like polyamides, which are about two times as costly as polyolefins.

All known composites of ligno-cellulosic fillers and thermoplastic matrix have in common to take up moisture, to swell and therefore increase in length, width and thickness. The swelling can be reduced by adding coupling agents like maleic acid anhydrate grafted polypropylene (MAA-PP) or polyethylene (MAA-PE). These coupling agents are believed to bind with their maleic acid anhydrate group to the hydroxyl groups of the cellulose and/or hemicellulose and to cover the carbohydrates with its polyolefin backbone to make it compatible with the polyolefin matrix polymer. NFPC swelling is much reduced compared to virgin wood but swelling happens over time in humid environments anyway. If not impregnated with biocides NFPCs are decayed by micro-organisms if applied within earth, in water contact, or in very humid surroundings.

During processing ligno-celluloses start to smell and to degrade when treated thermally too aggressively. For wood e.g. the thermal decomposition starts at 160° C., when degradation of hemicelluloses starts. Thermally treated hemicelluloses release acids like acetic acid and formic acid which cause a break down of the polymeric hemicellulose backbone generating monomers and derivatives from these monomers like furfural, 5-hydroxymethyl-furfural and others. Therefore extrusion or injection moulding with polypropylene at 210° C. at the tool at all times is critical in terms of smelling and fibre degradation. Higher temperatures cannot be applied without heavy thermal degradation, smelling and smoke formation.

The present invention aims to overcome swelling and smelling even at high processing temperatures up to 300° C., and also microbial deterioration, by use of modified ligno-cellulose.

### BRIEF SUMMARY OF THE INVENTION

This invention is a high temperature resistant composite comprised of modified ligno-cellulose and polymers, wherein the modified ligno-cellulose has a molar ratio of oxygen to carbon (O/C) from 0.3 to 0.6 and a molar ratio of hydrogen to carbon (H/C) from 0.9 to 1.6 and the polymers belong to the group of thermoplastic polymers.

### DESCRIPTION OF THE PREFERRED EMBODIMENT

Surprisingly it has now been found, that highly reducing or removing hemicelluloses from virgin ligno-cellulose creates a ligno-cellulose which does not smell in composites when extruded or injection moulded even at temperatures up to 300° C. It is also surprising that compounds with modified lignocelluloses can be as strong as those with virgin lignocelluloses.

Hemicelluloses can be preferably taken away by wet and/or dry thermal treatment under exclusion of oxygen (U.S. Pat. No. 4,215,151, US 2008/0223269, WO 2006/006863 A1, WO 2008/113309 A1, WO 2008/095589 A1), by chemical treatment, e.g. acid hydrolysis (WO 03/046227 A1), biochemical treatment, e.g. hydrolysis with hemicellulytic enzymes (hemicellulases) (EP 0 351 655 B1), or by the combining of these methods. Reducing or removing hemicelluloses makes the remaining ligno-cellulose much less hydrophilic by enriching the content of hydrophobic lignin in the remaining ligno-cellulose. High molecular weight cellulose itself, a carbohydrate like medium molecular weight hemicelluloses, is build up of amorphous and crystalline regions and therefore is much less hydrophilic as hemicelluloses.

To characterise the modified ligno-cellulose and to differentiate it from virgin ligno-cellulose, its molecular ratios of oxygen to carbon (O/C) and hydrogen to carbon (H/C) shall be a measure. Untreated hemicellulose containing, virgin ligno-cellulose e.g. from wood has an O/C from more than 0.6 and a H/C of more than 1.4. Charcoal made from wood at 350° C. up to 700° C. on the other hand has an O/C of about 0.3 or 0.03 respectively and a H/C of 0.85 or 0.28 respectively. Modified ligno-cellulose therefore is defined to have an O/C from 0.3 to 0.6 and a H/C of 0.9 to 1.6.

Modified ligno-cellulose derived by thermal treatment can be processed according to the state of the art with bulk thermoplastic polymers like polyethylene, polypropylene or polystyrene but also with technical plastics like polyamide 6 at 277° C. or with polyamide 6.6 at temperatures up to 300° C. without burning or smelling.

The polymers used to bind the modified ligno-cellulose belong to the group of thermoplastic polymers. Examples of thermoplastic polymers, not excluding others are polyolefins, vinyl polymers, polyesters, polyamides, acrylates, thermoplastic polyurethanes (TPU), thermoplastic bio-polymers, as homo or co-polymers or their derivatives, hot melts or mixtures of the above mentioned polymers. Examples given, but not excluding others, for polyolefins are linear or branched polyethylene (PE), as low, middle or high density types (LDPE, MDPE, HDPE) or polypropylene (PP), its co-polymers and/or derivatives. Examples given but not excluding others for vinyl polymers are polystyrene (PS) from low to very high molecular weight, with syn- or isotactical orientation, its co-polymers or derivatives e.g. acrylonitrile butadiene styrene (ABS) or acrylonitrile styrene acrylate (ASA), polyvinylchloride (PVC) its co-polymers or derivatives or ethylene vinyl acetate (EVA) its co-polymers or derivatives. Examples given, but not excluding others, for polyesters are polyethylene terephthalate (PET) its co-polymers or derivatives. Examples given, but not excluding others, for polyamides (PA) are polyamide 6 (PA 6), polyamide 6.6 (PA 6.6) its co-polymers or derivatives. Examples given, but not excluding others, for acrylates are polymethyl methacrylate (PMMA) its co-polymers or derivatives. Examples given, but not excluding others, for thermoplastic bio-polymers are poly lactic acid (PLA), poly hydroxyl butyrate (PHB), modified starches, thermoplastic cellulose derivatives, e.g. cellulose acetate (CA), its co-polymers or derivatives. Included are hot melts from single polymer types or mixtures of thermoplastic polymers. Included as well are mixtures of two or more of the above mentioned thermoplastic polymers.

The concentration in the invented composite of modified ligno-cellulose and thermoplastic polymer or polymers may vary from 5% (w/w) to 90% (w/w) of modified ligno-cellulose, preferably between 15% (w/w) and 45% (w/w) of modified ligno-cellulose and favourably between 20% (w/w) and 35% (w/w) of modified ligno-cellulose. For most technical applications the ligno-cellulose content is higher than 25% (w/w).

The invented composite shows in a preferred execution with modified ligno-cellulose as filler source less than 10% (w/w), preferred less than 5% (w/w) and favourable less than 3% (w/w) of water uptake after 5 h immersion in boiling water. The composite is dimensionally very stable in moist conditions or storage under water. After a 5 hour storage in boiling water volume swelling is less than 10%, preferred less than 5% and favourable less than 3%.

The invented composite does not degrade in earth contact. It shows less than 5% (w/w), preferred less than 3% and favourable less than 1% weight loss after 3 months exposure in earth contact.

The composite of modified ligno-cellulose and thermoplastic polymer(s) shows reduced thermal expansion and shrinkage compared to the unfilled polymer(s). Preferably the thermal expansion is reduced at least by 25% at filler loadings of 20%. According to the invention the thermal expansion coefficient of the composite containing 20% (w/w) or more of modified ligno-cellulose is equal or less than 25% compared to the unfilled matrix thermoplastic polymer/polymers.

Examples of invented composites are given below.

### EXAMPLE 1

50 parts of dry thermal treated modified ligno-cellulose from softwood with an O/C of 0.45 and a H/C 1.14 were compounded with 50 parts of polypropylene homopolymer Borealis PP HC205TF (melt flow rate MFR, 230° C./2.16 kg of 4) and 2 parts MAA-PP (Scona TPPP 8112 FA from Kometra, Germany) in a fluidizing and cooling mixer (FM40/KM85 from Henschel, Germany) at 140° C. jacket temperature of the fluidizing unit. 250 g of compound were pressed in a static press at 210° for 5 min. within a cavity tool of 200×200 mm resulting in a plate of 6 mm thickness and a density of 1.05 g/cm³. Flexural strength was 42.7 MPa, flexural E-modulus 3150 MPa, impact strength (notched) 2.4 kJ/m², water uptake after 5 hours immersion in boiling water was 2.9% (w/w) and volume swelling 2.2% (vol/vol).

### EXAMPLE 2

70 parts of modified ligno-cellulose with an O/C of 0.53 and a H/C of 1.4 were compounded with 30 parts of PP homopolymer MFR 4 (see example 1) in a fluidizing and cooling mixer (see example 1). The compound was injection moulded into test bars (dog bones) in an injection moulding machine at 210° C. (270 S 250-150 U—Arburg, Germany) and tested for mechanical performance. Flexural strength was about 51 MPa, flexural E-modulus 2230 MPa and notched impact strength was 1.9 kJ/m².

### EXAMPLE 3

30 parts of modified ligno-cellulose (see example 2) were compounded with 35 parts of recycling high density polyethylene (HDPE) and 35 parts of polystyrene (PS Empera 416N) in a fluidizing and cooling mixer (see example 1). The compound was injection moulded into test bars (see example 2) and tested for mechanical performance. Flexural strength was about 30 MPa, flexural E-modulus 2230 MPa and notched impact strength was 11.4 kJ/m².

### EXAMPLE 4

30 parts of modified ligno-cellulose (see example 2) were compounded with 35 parts of PP (MFR 4, see example 1), 35 parts of polystyrene (see example 3) and 2 parts of MAA-PP (see example 1) in a fluidizing and cooling mixer (see example 1). The compound was injection moulded into test bars (see example 2) and tested for mechanical performance. Flexural strength was about 42.5 MPa, flexural E-modulus about 2850 MPa and notched impact strength was 3.2 kJ/m².

### EXAMPLE 5

20 parts of modified ligno-cellulose (see example 1) were compounded with 80 parts of PA 6 (from Ashland Chemicals, USA) in a co-rotating twin screw extruder (Leistriz Micro-18/GL-40D, USA) at a maximum temperature of 232° C., extruded into a water bath, cut to pellets and dried at 80° C. before injection moulding. Injection moulding into testing bars was done at 277° C. (Model Sim-5080 from Technoplas, Inc., USA). Tensile strength was about 64 MPa as it was for the neat PA 6 and E-modulus increased from about 2800 MPa to 4100 MPa. Flexural strength was about 58 MPa as it was for the neat PA 6 and flexural E-modulus was increased from 1000 MPa to 1100 MPa compared to the neat PA 6. Notched impact strength was 2.8 kJ/m² which is reduced compared to neat PA 6 with 4.6 kJ/m². The test pieces didn't smell.

### EXAMPLE 6

20 parts of modified ligno-cellulose (see example 1) were compounded with 80 parts of PA 6.6 (from Ashland Chemicals, USA) containing 0.5% Titanium dioxide (TiO₂) in a co-rotating twin screw extruder (see example 5) but at a maximum temperature of 280° C. Injection moulding into testing bars was done at 300° C. (see example 5). Tensile strength was about 42 MPa compared to 68 for neat PA 6.6 and E-modulus increased compared to neat PA 6.6 from about 2700 MPa to 3900 MPa. Flexural strength was about 80 MPa as it was for the neat PA 6.6 and flexural E-modulus was increased from 1800 Mpa to 2600 MPa compared. Notched impact strength was 2.8 kJ/m² that is reduced compared to neat PA 6.6 with 4.7 kJ/m². The test pieces didn't smell.

Since certain changes may be made in the above described high temperature resistant composite without departing from the scope of the invention herein involved, it is intended that all matter contained in the description thereof shall be interpreted as illustrative and not in a limiting sense.

What is claimed is:

1. A high temperature resistant composite made from modified ligno-cellulose and polymers, comprising:
modified ligno-cellulose having a molar ratio of oxygen to carbon (O/C) from 0.3 to 0.6 and a molar ratio of hydrogen to carbon (H/C) from 0.9 to 1.6; and, thermoplastic polymers.

2. The composite according to claim 1 wherein the modified ligno-cellulose is made from virgin ligno-cellulose by reduction or total removal of hemicelluloses by means of wet treatment, dry treatment, chemical treatment, biochemical treatment, or by a combination of the treatments.

3. The Composite according to claim 1 wherein the modified ligno-cellulose content ranges from 5% (w/w) to 90% (w/w).

4. The Composite according to claim 1 wherein the modified ligno-cellulose content ranges from 15% (w/w) to 45% (w/w).

5. The Composite according to claim 1 wherein the modified ligno-cellulose content ranges from 20% (w/w) to 35% (w/w).

6. The composite according to claim 1 wherein said thermoplastic polymers are polyolefins, vinyl polymers, polyesters, polyamides, acrylates, or biopolymers, as well as said polyolefins', polyesters', polyamides', acrylates', or biopolymers' co-polymers derivatives and/or mixtures.

7. The composite according to claim 1 wherein the thermoplastic polymers are thermoplastic polyurethanes or hot melts from single polymer types.

8. The composite according to claim 1 wherein the thermoplastic polymers are mixtures of two or more thermoplastic polymers.

9. The composite according to claim 1 wherein the thermoplastic polymers are mixtures of two or more thermoplastic polymers

10. The composite according to claim 9 wherein the thermoplastic polymers are a mixture of polystyrene and polyolefin(s), including said polystyrene and polyolefin(s) co-polymers or derivatives.

11. The composite according to claim 1 wherein said composite does not rot in the presence of rotting micro-organism and wet conditions.

12. The composite according to claim 1 wherein said composite takes up water less than 10%, preferred less than 5% and mostly preferred less than 3% after 5 hours immersion in boiling water.

13. The composite according to claim 1 wherein said composite does not burn or smoke in plastic moulding treatments such as extrusion and injection moulding at temperatures up to 300° C.
